(19) United States
(12) Patent Application Publication
(10) Pub. No.: US 2009/0262156 A1
(43) Pub. Date: Oct. 22, 2009

(54) LIQUID DROPLET EJECTING HEAD AND IMAGE FORMING APPARATUS

(75) Inventors: Toshinobu Hamazaki, Kanagawa (JP); Toshinori Ishiyama, Kanagawa (JP); Shinji Seto, Kanagawa (JP); Naoki Morita, Kanagawa (JP)

Correspondence Address: FILDES & OUTLAND, P.C., 20916 MACK AVENUE, SUITE 2, GROSSE POINTE WOODS, MI, 48236, US

(73) Assignee: FUJI XEROX CO., LTD., Tokyo (JP)

(21) Appl. No.: 12/329,733

(22) Filed: Dec. 8, 2008

(30) Foreign Application Priority Data
Apr. 18, 2008 (JP) 2008-108748

(51) Int. Cl. B41J 29/38

(52) U.S. Cl. 347/11

(57) ABSTRACT

A liquid droplet ejecting head includes: an ejector having a nozzle, a pressure chamber, and a drive element that applies pressure to a liquid inside the pressure chamber; and a controller that applies a drive waveform to the drive element. The controller vibrates a flow velocity of the liquid ejected from the nozzle in a first positive direction vibration mode for causing a leading end portion of the liquid droplet to be ejected from the nozzle toward the opposite side of the pressure chamber side; and a second positive direction vibration mode for adjusting the velocity of a trailing end portion of the liquid droplet. An interval between the first positive direction vibration mode and the second positive direction vibration mode is set so as to make the velocity of the trailing end portion of the columnar liquid droplet faster than the velocity of the leading end portion thereof.

### CROSS-REFERENCE TO RELATED APPLICATION

This application is based on and claims priority under 35 USC 119 from Japanese Patent Application No. 2008-108748 filed on Apr. 18, 2008.

### BACKGROUND

### Technical Field

The present invention relates to a liquid droplet ejecting head that ejects liquid droplets and to an image forming apparatus disposed with the liquid droplet ejecting head.

### SUMMARY

A first aspect of the present invention is a liquid droplet ejecting head including: an ejector that includes a nozzle that ejects a liquid droplet, a pressure chamber that leads to the nozzle via a communication path, and a drive element that applies pressure to a liquid inside the pressure chamber; and a controller that applies a drive waveform based on image information to the drive element, the controller vibrating a flow velocity of the liquid in first and second positive direction vibration modes, in which ejection from the nozzle is carried out as a result of the controller applying the drive waveform to the drive element, where the first positive direction vibration mode is for causing a leading end portion of the liquid droplet to be ejected from the nozzle toward the opposite side of the pressure chamber side, the second positive direction vibration mode is for adjusting the velocity of a trailing end portion of the liquid droplet that has been ejected by the first positive direction vibration mode, and an interval between the first positive direction vibration mode and the second positive direction vibration mode is set so as to make the velocity of the trailing end portion of the columnar liquid droplet that is ejected from the nozzle faster than the velocity of the leading end portion of the liquid droplet.

### BRIEF DESCRIPTION OF THE DRAWINGS

Exemplary embodiments of the present invention will be described in detail based on the following figures, wherein:

FIG. 1 is a diagram showing, in a time series, the shape of an ink droplet that is ejected from a liquid droplet ejecting head that is employed in an image forming apparatus pertaining to a first exemplary embodiment of the present invention;

FIG. 2A and FIG. 2B are diagrams showing the ink flow velocity of a nozzle portion and a drive waveform that is applied to the liquid droplet ejecting head that is employed in the image forming apparatus pertaining to the first exemplary embodiment of the present invention;

FIG. 3A, FIG. 3B, FIG. 3C, FIG. 3D, FIG. 3E and FIG. 3F are cross-sectional diagrams showing change in the shape of a meniscus until an ink droplet is ejected from a nozzle of the liquid droplet ejecting head that is employed in the image forming apparatus pertaining to the first exemplary embodiment of the present invention;

FIG. 4A and FIG. 4B are diagrams showing the relationship between the velocity of an ink droplet (main droplet) that is ejected from the liquid droplet ejecting head that is employed in the image forming apparatus pertaining to the first exemplary embodiment of the present invention and the interval between a first positive direction vibration process and a second positive direction vibration process;

FIG. 5 is a diagram showing, in a time series, the shape of an ink droplet that is ejected from a liquid droplet ejecting head that is employed in an image forming apparatus serving as a comparative example of the present invention;

FIG. 6A and FIG. 6B are diagrams showing the ink flow velocity of a nozzle portion and a drive waveform that is applied to the liquid droplet ejecting head that is employed in the image forming apparatus serving as the comparative example of the present invention;

FIG. 7 is a cross-sectional diagram of the liquid droplet ejecting head that is employed in the image forming apparatus pertaining to the first exemplary embodiment of the present invention;

FIG. 8 is a plan diagram of the liquid droplet ejecting head that is employed in the image forming apparatus pertaining to the first exemplary embodiment of the present invention;

FIG. 9 is a schematic diagram showing the image forming apparatus pertaining to the first exemplary embodiment of the present invention; and

FIG. 10A and FIG. 10B are diagrams showing the ink flow velocity of a nozzle portion and a drive waveform that is applied to a liquid droplet ejecting head that is employed in an image forming apparatus pertaining to a second exemplary embodiment of the present invention.

### DETAILED DESCRIPTION

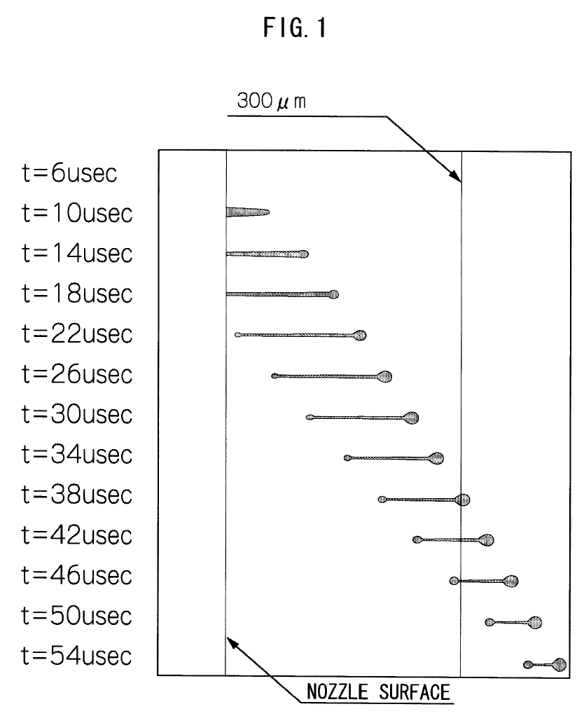

An example of an image forming apparatus in which a liquid droplet ejecting head pertaining to a first exemplary embodiment of the present invention is employed will be described in accordance with FIG. 1 to FIG. 9.

(Overall Configuration)

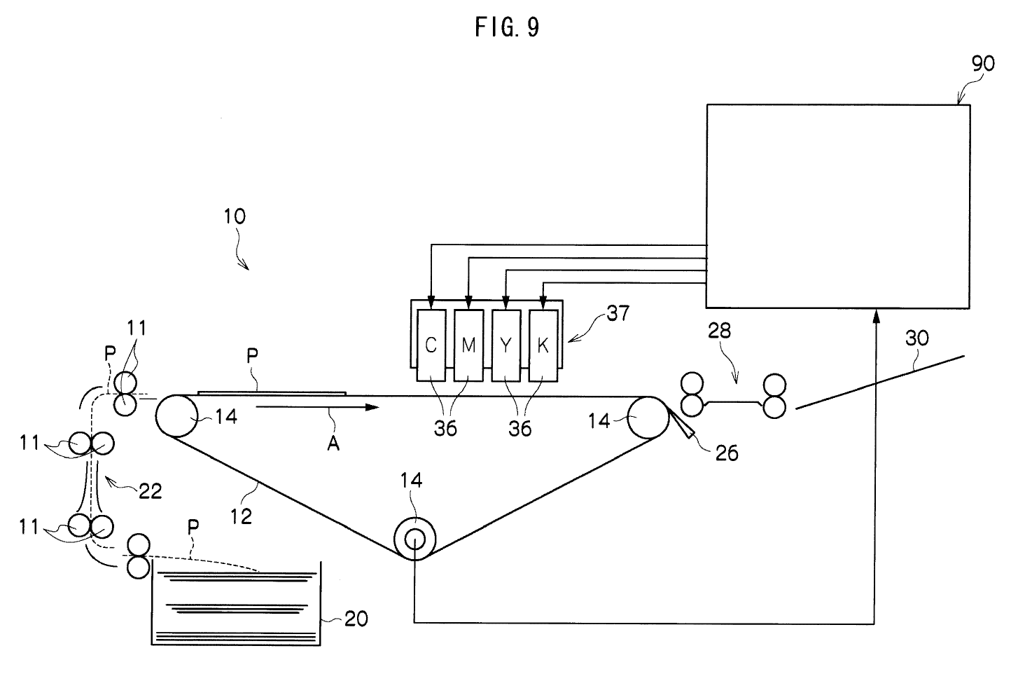

In FIG. 9, there is schematically shown the configuration of a full width array (FWA) inkjet printer (below, simply called “the printer”) 10 that is an image forming apparatus pertaining to the present exemplary embodiment.

A conveyor belt 12 is disposed in the printer 10, and the conveyor belt 12 is wound around plural rollers 14 and goes around in the direction indicated by arrow A in FIG. 9. One of the plural rollers 14 is configured as a drive roller that receives drive force of a driving device (not shown) and rotates, and the other rollers follow the rotation of the drive roller and rotate.

Further, a paper tray 20 is disposed in the printer 10, and sheet members P for recording an image are stacked and housed in the paper tray 20. The sheet members P that are housed in the paper tray 20 are picked up one sheet at a time from their uppermost layer by a pickup mechanism (not shown), guided along a paper supply conveyance path 22 by conveyance rolls 11, and fed to a predetermined position on the conveyor belt 12. It will be noted that the conveyor belt 12 is disposed with the function of closely holding the sheet members P. Thus, the sheet members P that have been fed from the paper supply conveyance path 22 are conveyed in the direction of arrow A in a state where they are closely held on the conveyor belt 12.

Moreover, a head array 37 is disposed along the conveyance path of the sheet members P on the conveyance direction downstream side of the predetermined position to which the sheet members P are fed on the conveyor belt 12. Four recording heads 36 that serve as liquid droplet ejecting heads for ejecting cyan (C) color ink, magenta (M) color ink, yellow (Y) color ink and black (K) color ink are disposed in this head array 37 from the upstream side in the direction in which the sheet members P are conveyed by the conveyor belt 12, and the sheet members P that are conveyed are sequentially caused to face each of the recording heads 36.

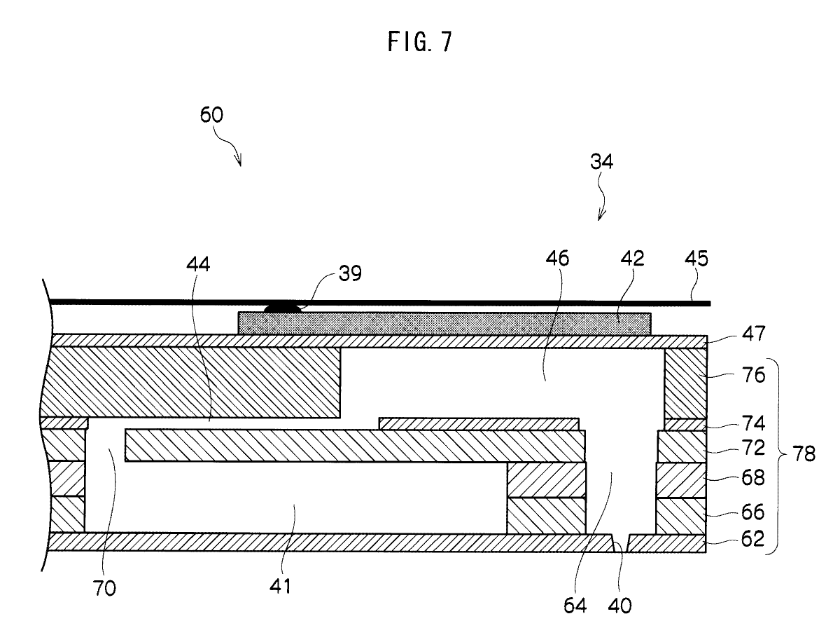

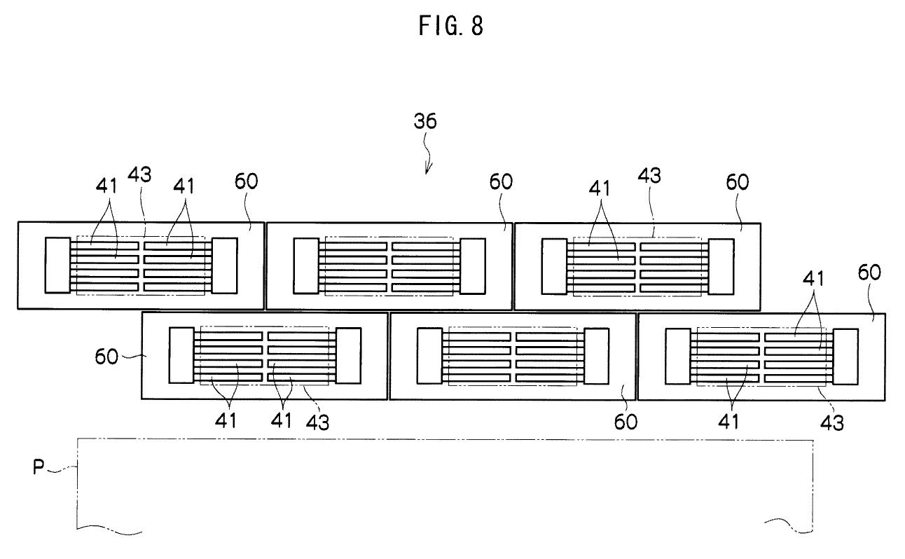

Additionally, on the basis of control by a recording head controller 90 that serves as a controller, ink droplets of each of the colors are ejected from nozzles 40 (see FIG. 7) that are disposed in ink head units 60 (see FIG. 8) of each of the recording heads 36. Thus, the ink droplets are ejected by each of the recording heads 36 that the sheet members P sequentially face onto, and a full color image is recorded on, the sheet members P that are closely held on the conveyor belt 12.

Further, a scraper 26 is disposed on the path on which the sheet members P are conveyed by the conveyor belt 12 and on the downstream side of the head array 37 so as to correspond to the disposed position of the roller 14 that is disposed in a position where the conveyance path curves, and the scraper 26 is configured to cause the sheet members P for which image recording has ended to separate from the conveyor belt 12 and feed those sheet members P to a paper discharge tray 30 via a discharge path 28.

Next, the recording heads 36 will be described.

As shown in FIG. 8, each of the recording heads 36 comprises an elongate head whose width is wider than the maximum width of the sheet members P. Moreover, each of the recording heads 36 is configured by plural rectangular ink head units 60 that serve as liquid droplet ejecting head units, and the ink head units 60 are arranged in two rows in a staggered manner so as to be offset by a half pitch between the upstream side and the downstream side of the sheet members P that are conveyed.

Moreover, a rectangular ejector region (ejector group array portion) 43 where plural ejectors 34 are arrayed is formed in each of the ink head units 60. Common flow paths 41 that supply ink from an ink cartridge (not shown) are plurally disposed in each of the ejector regions 43. These common flow paths 41 are communicated with the plural nozzles 40 (see FIG. 7).

As shown in FIG. 7, each of the ejectors 34 that are disposed in the ink head units 60 includes the nozzle 40 that ejects the ink, a pressure chamber 46 that is communicated with the nozzle 40, and the common flow path 41 that supplies the ink from the ink cartridge (not shown) to the pressure chamber 46.

A nozzle communication path 64 is disposed in the pressure chamber 46, and the nozzle 40 and the pressure chamber 46 are communicated by the nozzle communication path 64. Further, the pressure chamber 46 and the common flow path 41 are communicated by a communication path 70 and an ink supply path 44.

These are formed by laminating plates, and a flow path plate unit 78 is formed as a result of a nozzle plate 62 in which the nozzle 40 is formed, an ink pool plate 66 and an ink pool plate 68 in which the nozzle communication path 64 and the common flow path 41 are formed, a through plate 72 in which the communication path 70 of the common flow path 41 and the nozzle communication path 64 are formed, an ink supply path plate 74 in which the ink supply path 44 is formed and a pressure chamber plate 76 in which the pressure chamber 46 is formed being laminated in this order.

Further, the ceiling of the pressure chamber 46 is configured by a diaphragm 47, and a drive element 42 is attached to the diaphragm 47. Moreover, a substrate 45 is disposed above the drive element 42 and is joined to the drive element 42 via a solder bump 39.

Because of this configuration, the drive element 42, to which a determined drive waveform is applied by the recording head controller 90, causes pushing force with respect to the diaphragm 47 to change and causes the volume inside the pressure chamber 46 to contract or expand. In other words, because of the change in the volume inside the pressure chamber 46, the ink that is stored in the pressure chamber 46 passes through the nozzle communication path 64, becomes an ink droplet and is ejected from the nozzle 40.

(Relevant Portions)

Next, the natural vibration period (Tc) of the ejector 34 and the drive waveform that the recording head controller 90 applies to the drive element 42 will be described.

As shown in FIG. 7, the natural vibration period (Tc) of the ejector 34 is configured to be 8 μsec by appropriately setting the size of the pressure chamber 46, the shape of the nozzle 40 and the length of the nozzle communication path 64.

It will be noted that the natural vibration period (Tc) is determined by the following formulas. As will be understood from these formulas, in order to shorten the natural vibration period (Tc), it suffices to reduce a compliance C of the pressure chamber 46 and a composite inertance M. In order to reduce the compliance C, it suffices to reduce the size of the pressure chamber 46. In order to reduce the composite inertance M, it suffices to reduce an inertance Mn of the nozzle portion and an inertance Ms of the supply path, and to that end, it suffices to shorten the lengths of the nozzle 40 and the nozzle communication path 64 and to increase their cross-sectional areas.

Tc=2π\sqrt{M×C}

1/M=1/Mn+1/Ms
Tc: natural vibration period
C: compliance of pressure chamber
M: composite inertance
Mn: inertance of nozzle portion
Ms: inertance of supply path

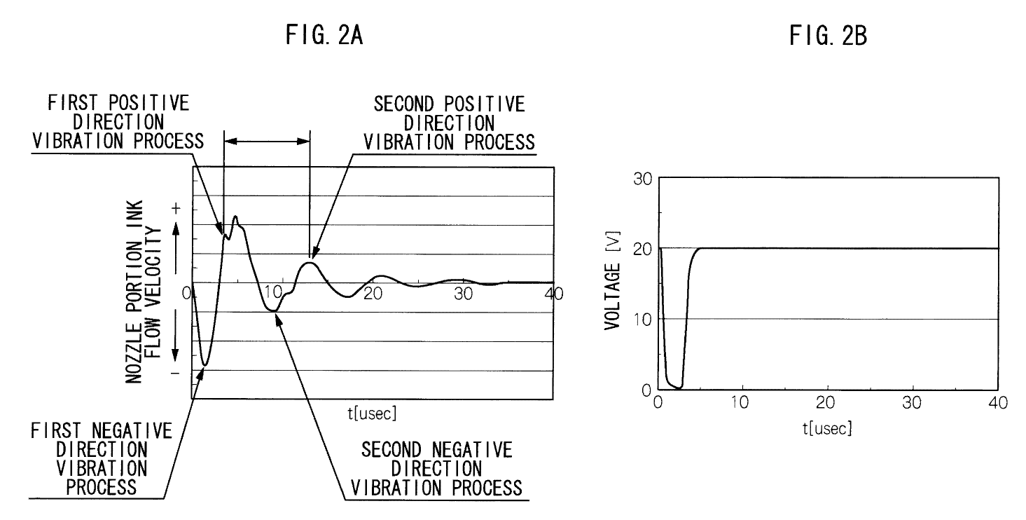

Further, as shown in FIG. 2B, the drive waveform that is applied to the drive element 42 is configured as a simple pulse. This drive waveform has a configuration where it is maintained at a bias voltage (in the present exemplary embodiment, 20 V), and when the voltage drops, the pressure chamber 46 expands such that the flow velocity of the ink in the vicinity of the nozzle 40 is made into a negative direction (opposite direction of ejection), and when the voltage rises, the pressure chamber 46 contracts such that the flow velocity is made into a positive direction (ejection direction). Further, the pulse width is configured to be substantially ½ of 8 μsec in consideration of the aforementioned natural vibration period (Tc).

(Action and Effects)

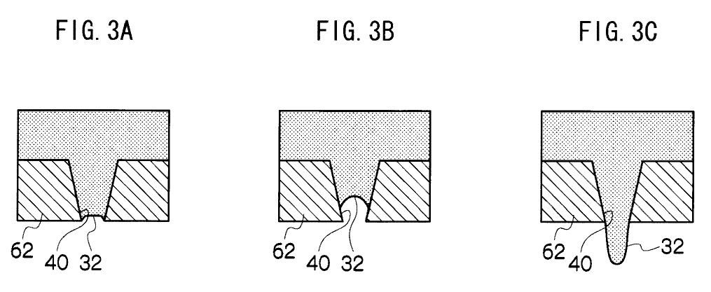

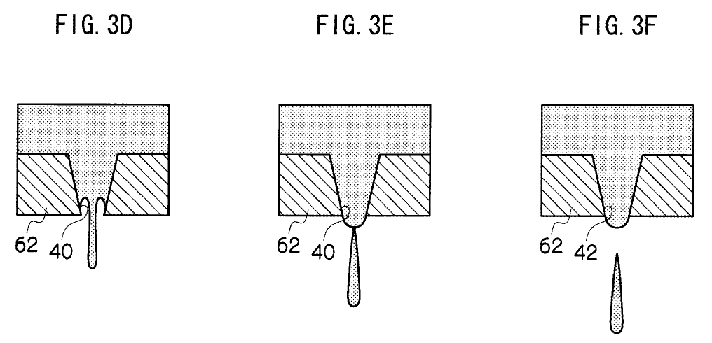

As shown in FIG. 3A, before the recording head controller 90 applies the drive waveform to the drive element 42, a meniscus 32 of the nozzle 40 is held on the nozzle end portion in a state where capillary force and ink back pressure (negative pressure) are balanced.

As shown in FIG. 3B, the recording head controller 90 applies the drive waveform to the drive element 42, and when the voltage drops, the pressure chamber 46 (see FIG. 7) expands such that the meniscus 32 of the nozzle 40 is pulled inside the nozzle 40 (first negative direction vibration process (first negative direction vibration mode)).

Next, as shown in FIG. 3C, when the voltage that has dropped rises, the pressure chamber 46 (see FIG. 7) contracts such that the meniscus 32 of the nozzle 40 grows outside the nozzle 40, pushes out a leading end portion of a liquid column, and causes the leading end portion of the liquid column to move by inertial force (first positive direction vibration process (first positive direction vibration mode)).

Next, as shown in FIG. 3D, a flow arises which pulls a trailing end portion of the liquid column inside the nozzle 40 and makes the trailing end portion of the liquid column slender (second negative direction vibration process (second negative direction vibration mode)).

Next, as shown in FIG. 3E, a flow arises which pushes the trailing end portion of the liquid column outside the nozzle 40 and causes the velocity of the trailing end portion of the liquid column to accelerate (second positive direction vibration process (second positive direction vibration mode)). Then, as shown in FIG. 3F, the liquid column is cut from the ink inside the nozzle 40 and a columnar ink droplet (liquid droplet) is ejected toward the sheet member P. The ink droplet is ejected by so-called “pulling and hitting” in which the meniscus 32 is pulled inside the nozzle 40 once and then the ink droplet is ejected.

Next, the ink flow velocity, in the vicinity of the nozzle 40, of the ink droplet that is ejected in this manner will be described.

The vertical axis of the graph in FIG. 2A represents the ink flow velocity of the ink that is ejected from the nozzle 40 in the vicinity of the nozzle 40, with the positive direction being velocity in the direction where the ink is ejected from the nozzle 40 and the negative direction being velocity in the direction where the ink is pulled inside the nozzle 40. Further, the horizontal axis of the graph represents time.

The first negative direction vibration process (see FIG. 3B), the first positive direction vibration process (see FIG. 3C), the second negative direction vibration process (see FIG. 3D) and the second positive direction vibration process (see FIG. 3E) are indicated in the graph. As will be understood from this diagram, by making the natural vibration period (Tc) of the ejector 34 equal to 8 μsec, the interval between the first positive direction vibration process and the second positive direction vibration process is determined so as to become shorter in comparison to a later-described case where the natural vibration period (Tc) is 11 μsec.

Here, the inventor of the present application uses the ejector 34 whose natural vibration period (Tc) is configured to be 8 μsec, applies the drive waveform shown in FIG. 2B to the drive element 42, and actually evaluates the ink droplet that is ejected from the nozzle 40.

Specifically, the ink droplet that is ejected from the nozzle 40 is ejected from the nozzle 40 in a columnar shape. Additionally, the columnar ink droplet is disposed with a relatively large main droplet that is positioned on the leading end portion and a satellite droplet that is formed accompanying the main droplet and positioned on the trailing end portion. The main droplet and the satellite droplet are evaluated.

As for the method of evaluation, the shape of the ink droplet that is ejected from the nozzle 40 is ascertained per amount of time from the side, and whether or not the satellite droplet catches up to and coalesces with the main droplet and flies at a position 700 μm away from the nozzle surface is evaluated.

It will be noted that, ordinarily, in the case of an image forming apparatus, it is common for the sheet member P that serves as a recording medium to be positioned in a position 1 mm to 1.5 mm away from the nozzle 40. The purpose of the investigation this time is to ascertain whether or not the main droplet and the satellite droplet coalesce before reaching the sheet member P, and this is evaluated at a position 700 μm away from the nozzle surface as an example, but it suffices as long as the main droplet and the satellite droplet coalesce before reaching the sheet member P, and the position is not limited to 700 μm.

In FIG. 1, the shape of the ink droplet that is ejected from the nozzle 40 as seen from the side is shown in a time series. The nozzle surface from which the ink droplet is ejected is shown on the left side of the page, and a line 300 μm away from the nozzle surface is shown on the right side of the page.

As will be understood from this, the velocity of the satellite droplet of the columnar ink droplet (the velocity of the trailing end of the ink droplet) that is ejected from the nozzle 40 is faster than the velocity of the main droplet (the velocity of the leading end of the ink droplet), so at the position 700 μm away from the nozzle surface, the satellite droplet catches up to and coalesces with the main droplet and flies.

Next, as a comparative example of the present invention, the inventor of the present application uses an ejector whose natural vibration period (Tc) is configured to be 11 μsec and ascertains the ink droplet that is ejected from the nozzle.

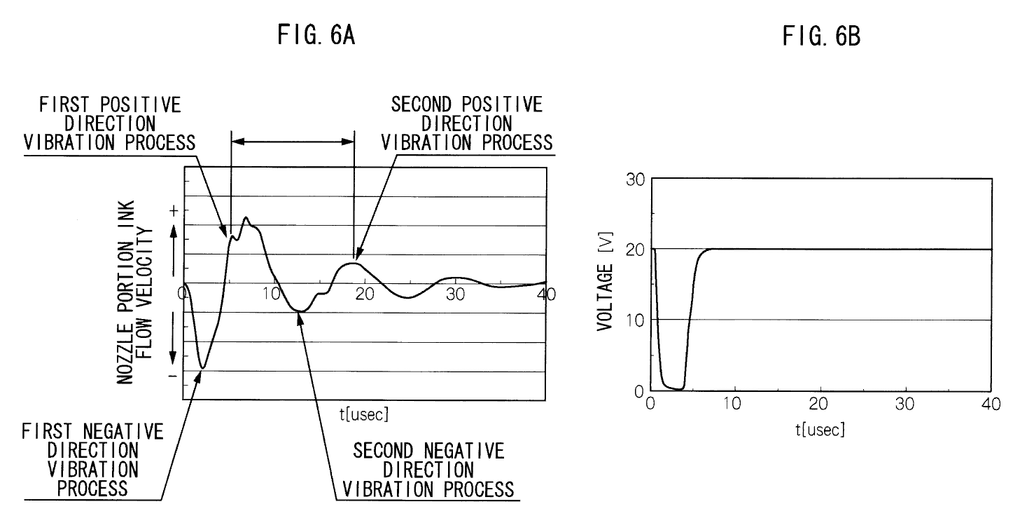

As shown in FIG. 6B, the pulse width is configured to be substantially ½ of 11 μsec in consideration of the natural vibration period (Tc).

As shown in FIG. 6A, by making the natural vibration period (Tc) of the ejector equal to 11 μsec, the interval between the first positive direction vibration process and the second positive direction vibration process cannot be shortened and, in comparison to the present invention where the natural vibration period (Tc) is 8 μsec, the interval between the first positive direction vibration process and the second positive direction vibration process spreads.

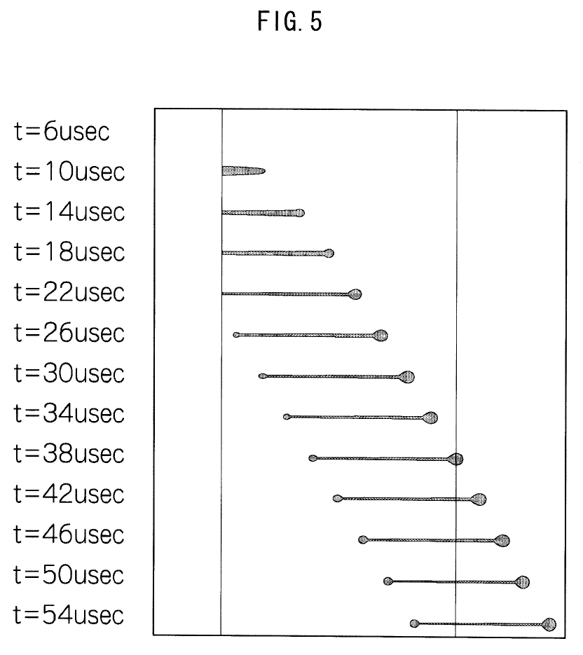

Moreover, as will be understood from FIG. 5, the velocity of the satellite droplet of the columnar ink droplet (the velocity of the trailing end of the ink droplet) that is ejected from the nozzle is virtually no different from the velocity of the main droplet (the velocity of the leading end of the ink droplet), so at the position 700 μm away from the nozzle surface, the satellite droplet does not catch up to and does not coalesce with the main droplet.

In other words, by making the natural vibration period (Tc) equal to 8 μsec and shortening (determining) the interval between the first positive direction vibration period and the second positive direction vibration period, the velocity of the satellite droplet (the velocity of the trailing end of the ink droplet) becomes faster than the velocity of the main droplet (the velocity of the leading end of the ink droplet), and at the position 700 μm away from the nozzle surface, the satellite droplet catches up to and coalesces with the main droplet and flies.

Next, the inventor of the present application changes the parameters of the nozzle diameter and the surface tension (viscosity) of the ink and evaluates whether or not the satellite droplet catches up to and coalesces with the main droplet at the position 700 μm away from the nozzle surface.

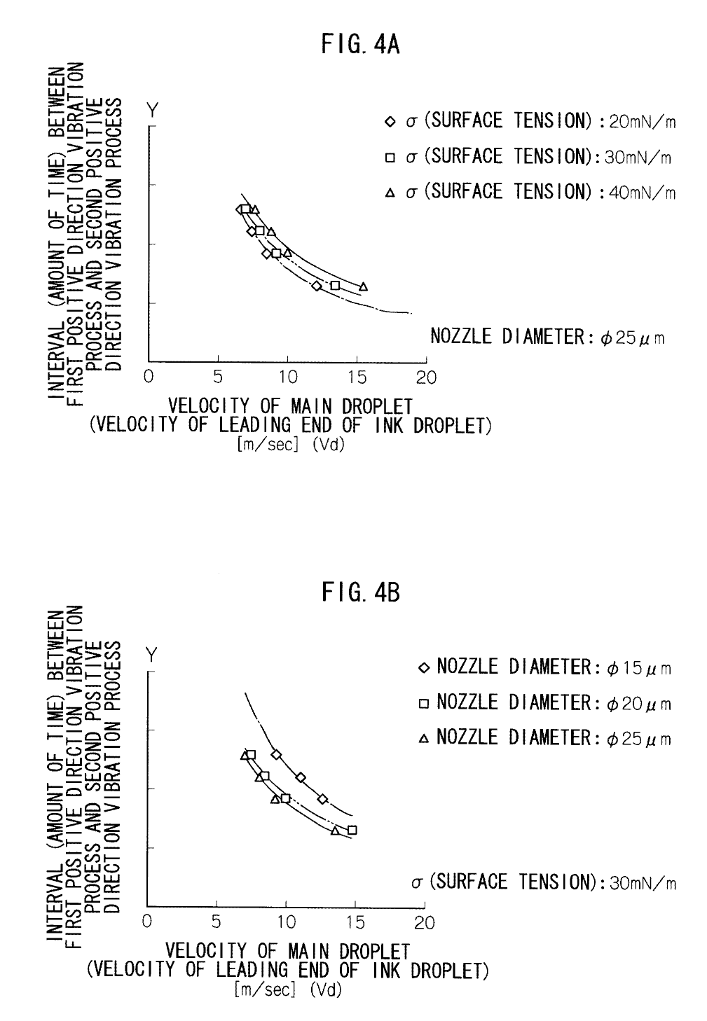

The horizontal axis in FIG. 4A represents the velocity of the main droplet (the velocity of the leading end of the ink droplet), and the vertical axis represents the interval between the first positive direction vibration process and the second positive direction vibration process. The nozzle diameter is fixed at Φ25 μm and the surface tension (σ) of the ink is evaluated at three levels of 20 mN/m, 30 mN/m and 40 mN/m.

Whether or not the satellite droplet catches up to and coalesces with the main droplet largely depends on the velocity of the main droplet (leading end of the liquid column), and when the drive conditions (natural vibration period, drive waveform) are fixed, the ink droplet can be ejected more stably when the velocity of the main droplet (the velocity of the leading end of the ink droplet) is fast, but the satellite droplet no longer catches up to the main droplet and the satellite droplet no longer coalesces with the main droplet. On the other hand, when the velocity of the main droplet is made slower, it becomes easier for the satellite droplet to coalesce with the main droplet, but the ink droplet is no longer ejected stably.

Thus, the relationship between the velocity of the main droplet (the velocity of the leading end of the ink droplet) and the interval (amount of time) between the first positive direction vibration process and the second positive direction vibration process is graphed separating the surface tension (σ) of the ink into three levels of 20 mN/m, 30 mN/m and 40 mN/m. In other words, when the velocity of the main droplet at which the ink droplet can be stably ejected is determined, the interval (amount of time) between the first positive direction vibration process and the second positive direction vibration process of an upper limit where the satellite droplet can coalesce with the main droplet with respect to that velocity is plotted separately by the surface tension of the ink.

With respect to when the surface tension (σ) of the ink is 20 mN/m, when Y represents the interval between the first positive direction vibration process and the second positive direction vibration process and Vd represents the velocity of the main droplet (the velocity of the leading end), it will be understood that the relationship of Y=105.17×Vd^{-1.1187} is established.

Further, with respect to when the surface tension (σ) of the ink is 30 mN/m, when Y represents the interval between the first positive direction vibration process and the second positive direction vibration process and Vd represents the velocity of the main droplet (the velocity of the leading end), it will be understood that the relationship of Y=92.646×Vd^{-1.0221} is established.

Moreover, with respect to when the surface tension (σ) of the ink is 40 mN/m, when Y represents the interval between the first positive direction vibration process and the second positive direction vibration process and Vd represents the velocity of the main droplet (the velocity of the leading end), it will be understood that the relationship of Y=86.941×Vd^{-0.9492} is established.

In contrast, the surface tension (σ) of the ink is fixed to 30 mN/m and the nozzle diameter is evaluated at three levels of Φ15 μm, Φ20 μm and Φ25 μm. The horizontal axis in FIG. 4B represents the velocity of the main droplet (the velocity of the leading end of the ink droplet), and the vertical axis represents the interval (amount of time) between the first positive direction vibration process and the second positive direction vibration process.

With respect to when the nozzle diameter is Φ15 μm, when Y represents the interval between the first positive direction vibration process and the second positive direction vibration process and Vd represents the velocity of the main droplet (the velocity of the leading end), it will be understood that the relationship of Y=168.76×Vd^{-1.1451} is established.

Further, with respect to when the nozzle diameter is Φ20 μm, when Y represents the interval between the first positive direction vibration process and the second positive direction vibration process and Vd represents the velocity of the main droplet (the velocity of the leading end), it will be understood that the relationship of Y=93.305×Vd^{-0.9919} is established.

Moreover, with respect to when the nozzle diameter is Φ25 μm, when Y represents the interval between the first positive direction vibration process and the second positive direction vibration process and Vd represents the velocity of the main droplet (the velocity of the leading end), it will be understood that the relationship of Y=92.646×Vd^{-1.0221} is established.

From the above results, assuming that Y represents the interval between the first positive direction vibration mode and the second positive direction vibration mode, when the velocity Vd of the leading end of the liquid droplet and the interval Y between the first positive direction vibration mode and the second positive direction vibration mode satisfy the formula Y≦A×Vd^{B}, where A and B vary according to circumstances, within 86.941≦A≦168.76 and −1.1451≦B≦−0.9492, a stable ink droplet is ejected from the nozzle, the satellite droplet catches up to the main droplet, and the satellite droplet and the main droplet coalesce.

It will be noted that, although the present invention has been described in detail in regard to a specific exemplary embodiment, the present invention is not limited to this exemplary embodiment, and it will be apparent to those skilled in the art that various other embodiments are possible within the scope of the present invention. For example, in the preceding exemplary embodiment, the natural vibration period (Tc) of the ejector 34 was described as being 8 μsec, but the natural vibration period is not limited to this; it suffices to adjust (determine) the natural vibration period (Tc) such that the velocity of the trailing end of the columnar ink droplet that is ejected from the nozzle 40 becomes faster than the velocity of the leading end of the ink droplet.

Further, in the preceding exemplary embodiment, the liquid droplets that are ejected from the recording heads 36 have been described as being limited to ink droplets, but it is not the case that the liquid droplets are limited to ink droplets. The present invention is also capable of being applied to liquid droplet ejecting heads directed toward various industrial purposes, such as, for example, the formation of bumps for mounting parts, which is performed by ejecting molten solder onto a substrate, and the formation of EL display panels, which is performed by ejecting an organic EL solution onto a substrate.

Further, in the preceding exemplary embodiment, an image forming apparatus the uses the elongate recording heads 36 to eject ink droplets in a state where the recording heads 36 are fixed has been taken as an example and described, but the image forming apparatus may also be an image forming apparatus where the recording heads scan in the width direction of the sheet members P and eject ink droplets while scanning.

Further, in the preceding exemplary embodiment, the drive waveform shown in FIG. 2B is applied such that the velocity of the trailing end of the columnar ink droplet that is ejected from the nozzle 40 becomes faster than the velocity of the leading end of the ink droplet, but the drive waveform may also be another drive waveform that makes the velocity of the trailing end of the columnar ink droplet that is ejected from the nozzle faster than the velocity of the leading end of the ink droplet.

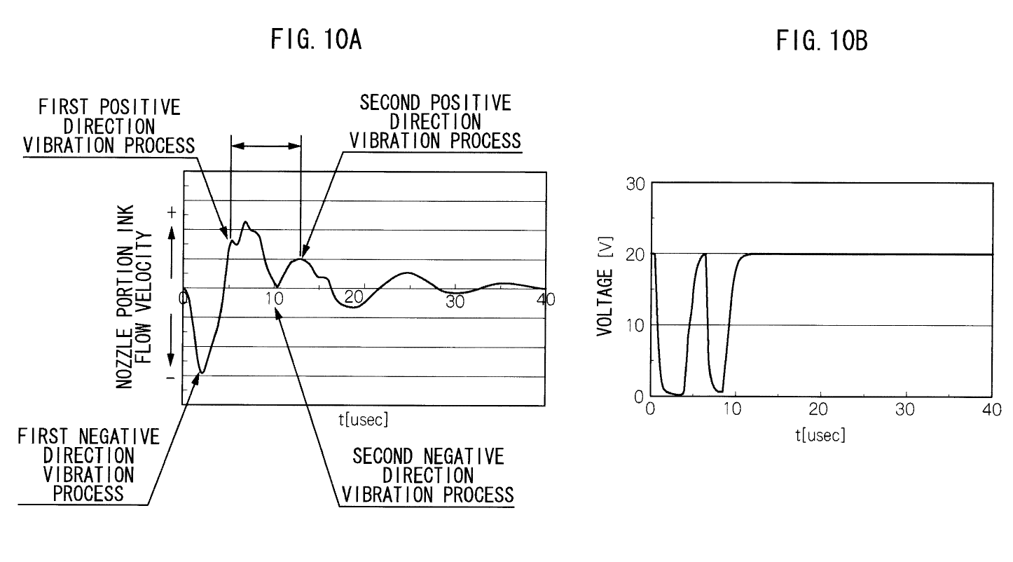

Next, an example of an image forming apparatus where a liquid droplet ejecting head pertaining to a second exemplary embodiment of the present invention is employed will be described in accordance with FIG. 10A and FIG. 10B.

It will be noted that the same reference numerals will be given to members that are identical to those in the first exemplary embodiment and that description thereof will be omitted.

In the present exemplary embodiment, the natural vibration period (Tc) of the ejector is not configured to be 8 μsec but is instead configured to be 11 μsec.

Moreover, as shown in FIG. 10B, the drive waveform that is applied to the drive element 42 is not a simple pulse by is disposed with a main pulse that causes the ink droplet to be ejected and an additional pulse that is shorter than the pulse width of the main pulse and which is applied after the main pulse.

In this manner, even when the natural vibration period (Tc) of the ejector 34 is long (11 μsec), as shown in FIG. 10A, the additional pulse is timely applied, whereby the phase largely shifts and the interval (amount of time) between the first positive direction vibration process and the second positive direction vibration process is determined so as to become short.

Moreover, because the interval between the first positive direction vibration process and the second positive direction vibration process becomes short, the velocity of the satellite droplet (the velocity of the trailing end of the ink droplet) becomes faster than the velocity of the main droplet (the velocity of the leading end of the ink droplet), and the satellite droplet catches up to and coalesces with the main droplet and flies.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A liquid droplet ejecting head comprising:
an ejector that includes a nozzle that ejects a liquid droplet, a pressure chamber that leads to the nozzle via a communication path, and a drive element that applies pressure to a liquid inside the pressure chamber; and
a controller that applies a drive waveform based on image information to the drive element, the controller vibrating a flow velocity of the liquid in first and second positive direction vibration modes, in which ejection from the nozzle is carried out as a result of the controller applying the drive waveform to the drive element, where the first positive direction vibration mode is for causing a leading end portion of the liquid droplet to be ejected from the nozzle toward the opposite side of the pressure chamber side, the second positive direction vibration mode is for adjusting the velocity of a trailing end portion of the liquid droplet that has been ejected by the first positive direction vibration mode, and an interval between the first positive direction vibration mode and the second positive direction vibration mode is set so as to make the velocity of the trailing end portion of the columnar liquid droplet that is ejected from the nozzle faster than the velocity of the leading end portion of the liquid droplet.

2. The liquid droplet ejecting head of claim 1, wherein the setting of the interval between the first positive direction vibration mode and the second positive direction vibration mode is performed by adjusting the natural vibration period of the ejector.

3. The liquid droplet ejecting head of claim 1, wherein the interval between the first positive direction vibration mode and the second positive direction vibration mode is set by adjusting the drive waveform that the controller applies to the drive element.

4. The liquid droplet ejecting head of claim 1, wherein when Vd represents the velocity of the leading end of the liquid droplet that is ejected from the nozzle, and Y represents the interval between the first positive direction vibration mode and the second positive direction vibration mode, the velocity Vd of the leading end of the liquid droplet and the interval Y between the first positive direction vibration mode and the second positive direction vibration mode satisfy the formula Y≦A×Vd^{B}, where A and B vary according to circumstances, within 86.941≦A≦168.76 and −1.1451≦B≦−0.9492.

5. An image forming apparatus comprising:
a conveyance mechanism that conveys a recording medium; and
a liquid droplet ejecting head that ejects a liquid droplet onto the recording medium that is conveyed by the conveyance mechanism,
the liquid droplet ejecting head comprising
an ejector that includes a nozzle that ejects the liquid droplet, a pressure chamber that leads to the nozzle via a communication path, and a drive element that applies pressure to a liquid inside the pressure chamber and
a controller that applies a drive waveform based on image information to the drive element, the controller vibrating a flow velocity of the liquid in first and second positive direction vibration modes, in which ejection from the nozzle is carried out as a result of the controller applying the drive waveform to the drive element, where the first positive direction vibration mode is for causing a leading end portion of the liquid droplet to be ejected from the nozzle toward the opposite side of the pressure chamber side, the second positive direction vibration mode is for adjusting the velocity of a trailing end portion of the liquid droplet that has been ejected by the first positive direction vibration mode, and an interval between the first positive direction vibration mode and the second positive direction vibration mode is set so as to make the velocity of the trailing end portion of the columnar liquid droplet that is ejected from the nozzle faster than the velocity of the leading end portion of the liquid droplet.

6. A liquid droplet ejecting head comprising:
an ejector that includes a nozzle that ejects a liquid droplet, a pressure chamber that leads to the nozzle via a communication path, and a drive element that applies pressure to a liquid inside the pressure chamber; and
a controller that applies a drive waveform based on image information to the drive element, the controller vibrating a flow velocity of the liquid in first and second positive direction vibration modes, in which ejection from the nozzle is carried out as a result of the controller applying the drive waveform to the drive element, where the first positive direction vibration mode is for causing a leading end portion of the liquid droplet to be ejected from the nozzle toward the opposite side of the pressure chamber side, the second positive direction vibration mode is for adjusting the velocity of a trailing end portion of the liquid droplet that has been ejected by the first positive direction vibration mode, and when Vd represents the velocity of the leading end of the liquid droplet that is ejected from the nozzle, and Y represents the interval between the first positive direction vibration mode and the second positive direction vibration mode, the velocity Vd of the leading end of the liquid droplet and the interval Y between the first positive direction vibration mode and the second positive direction vibration mode satisfy the formula Y≦A×Vd^{B}, where A and B vary according to circumstances, within 86.941≦A≦168.76 and −1.1451≦B≦−0.9492.

7. The liquid droplet ejecting head of claim 6, wherein the interval between the first positive direction vibration mode and the second positive direction vibration mode is set by adjusting the natural vibration period of the ejector.

8. The liquid droplet ejecting head of claim 6, wherein the controller is capable of adjusting the drive waveform that the controller applies to the drive element, and the interval between the first positive direction vibration mode and the second positive direction vibration mode is set by adjusting the drive waveform.

9. An image forming apparatus comprising:
a conveyance mechanism that conveys a recording medium; and
a liquid droplet ejecting head that ejects a liquid droplet onto the recording medium that is conveyed by the conveyance mechanism,
the liquid droplet ejecting head comprising
an ejector that includes a nozzle that ejects a liquid droplet, a pressure chamber that leads to the nozzle via a communication path, and a drive element that applies pressure to a liquid inside the pressure chamber and
a controller that applies a drive waveform based on image information to the drive element, the controller vibrating a flow velocity of the liquid in first and second positive direction vibration modes, in which ejection from the nozzle is carried out as a result of the controller applying the drive waveform to the drive element, where the first positive direction vibration mode is for causing a leading end portion of the liquid droplet to be ejected from the nozzle toward the opposite side of the pressure chamber side, the second positive direction vibration mode is for adjusting the velocity of a trailing end portion of the liquid droplet that has been ejected by the first positive direction vibration mode, and when Vd represents the velocity of the leading end of the liquid droplet that is ejected from the nozzle, and Y represents the interval between the first positive direction vibration mode and the second positive direction vibration mode, the velocity Vd of the leading end of the liquid droplet and the interval Y between the first positive direction vibration mode and the second positive direction vibration mode satisfy the formula Y≦A×Vd^{B}, where A and B vary according to circumstances, within 86.941≦A≦168.76 and −1.1451≦B≦−0.9492.

10. The image forming apparatus of claim 9, wherein the interval between the first positive direction vibration mode and the second positive direction vibration mode is set by adjusting the natural vibration period of the ejector.
